(19) United States
(12) Patent Application Publication
(10) Pub. No.: US 2006/0113137 A1
(43) Pub. Date: Jun. 1, 2006

(54) Two-wheel drive motorcycle of belly roll type

(76) Inventor: Jung-Ming Lin, Keelung City (TW)

Correspondence Address: DENNISON, SCHULTZ, DOUGHERTY & MACDONALD, 1727 KING STREET, SUITE 105, ALEXANDRIA, VA, 22314, US

(21) Appl. No.: 10/997,968

(22) Filed: Nov. 29, 2004

(51) Int. Cl. B62B 5/02

(52) U.S. Cl. 180/244; 280/5.24

(57) ABSTRACT

A 2WD motorcycle of belly roll type mainly comprises a motorcycle as a body; a hydraulic pump is provided on the motorcycle, the hydraulic pump is connected to a hydraulic motor at a front wheel of the motorcycle through a high-pressure fuel feed hose to drive the front wheel; the motorcycle's belly is provided with a roller device comprised of a block and several rollers; a bottom of the block is upward concaved with a container portion, a top of the block has several locking portions, a side of the block is formed with several piercing holes piercing through two walls of the block; central axis at two sides of each roller is protruded with a roller axis; each roller is allowed in the container portion of the block and pierces through the piercing holes at two sides of the walls of the block according to the axis.

### BACKGROUND OF THE INVENTION

1. Field of the Invention

This invention relates to a two-wheel drive (2WD) motorcycle of belly roll type and particularly to a two-wheel drive (2WD) motorcycle of belly roll type simultaneously driving its front and rear wheels to roll and keeping its belly from being seized on a higher inclined slope which it passes through.

2. Description of the Prior Art

A conventional motorcycle runs by rear wheel drive and runs on a general road without problems causing; however, a special cross-country racing motorbike races in an open country or a special cross-country gymkhana instead of the general road, and thus when the motorcycle of rear wheel drive races in the fields, quite many problems occurs—for example, when running on sands or a stony path, due to a main power from the rear wheel, the motorcycle cannot get out of the sands or the stony path by itself if its idle running results from a skid of the rear wheel, and further the rider will easily fall over and hurt; further, when the motorcycle runs up the higher inclined slope, its belly is easily seized at an included angle between the slope and a plane to damage the motorcycle and endanger the rider due to the front wheel having passed the slope but the rear wheel still running on the slope.

Thus, it can be seen that the conventional product has none the less many defects, so it is not a good design so as to urgently improve.

In consideration of the various defects derived from the conventional 2WD motorcycle of belly roll type, this inventor further improves it and finally successfully develops the 2WD motorcycle of belly roll type according to this invention after having made extraordinarily painstaking efforts to study the motorbike diligently with a quiet mind for many years.

### SUMMARY OF THE INVENTION

This invention is to provide a 2WD motorcycle of belly roll type simultaneously driving its front and rear wheels to roll.

This invention is next to provide a 2WD motorcycle of belly roll type keeping its belly from being seized on a higher inclined slope that it passes through.

For that purpose mentioned above, the 2WD motorcycle of belly roll type comprises:

a motorcycle on which a clutch control handle is provided to join a drive gear of an engine installed on the motorcycle for control to a clutch;

a hydraulic pump on which a high-pressure fuel feed hose is provided to connect with a hydraulic motor, the fuel feed hose being provided with a back pressure valve and a directional control valve;

a hydraulic motor provided at a side of the front wheel of motorcycle and connected to a wheel axle of the front wheel, the hydraulic motor being provided with a low-pressure fuel feed hose connected to a fuel tank;

a fuel tank on which a hydraulic hose is provided to connect with the hydraulic pump;

a roller device formed with a block and several rollers, a bottom of the block being upward concaved with a container portion, a top of the bottom being provided with several locking portions, and a side of the block being formed with several piercing holes piercing through two walls of the block; central axis at two sides of each roller being protruded with a roller axis; each roller being allowed in the container portion of the block and piercing through the piercing holes at two sides of the walls of the block according to the roller axis.

### BRIEF DESCRIPTION OF THE DRAWINGS

The drawings disclose an illustrative embodiment of the present invention which serves to exemplify the various advantages and objects hereof, and are as follows:

FIG. 1 is a side view of a 2WD motorcycle of belly roll type according to this invention;

FIG. 2 is a view of a system structure of the 2WD motorcycle of belly roll type;

FIG. 3 is a 3D exploded view of a roller device;

FIG. 3A is a 3D exploded view of another embodiment of the roller device;

FIG. 4 is a view of a hydraulic loop of the 2WD motorcycle of belly roll type according to this invention; and

FIG. 5 is a view of the hydraulic loop of both front wheel and rear wheel driven by a hydraulic motor.

### DETAILED DESCRIPTION OF THE PREFERRED EMBODIMENT

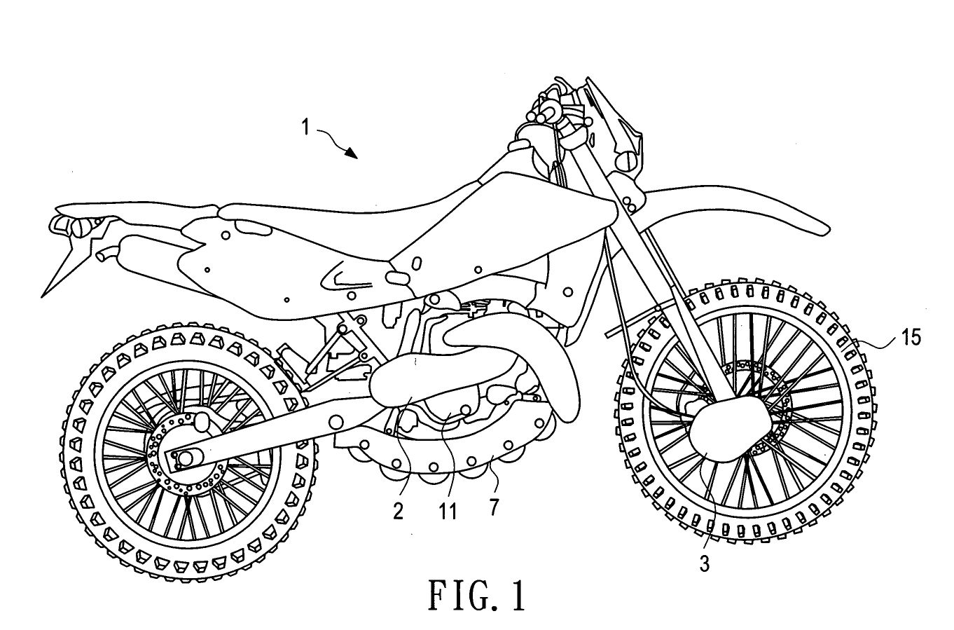

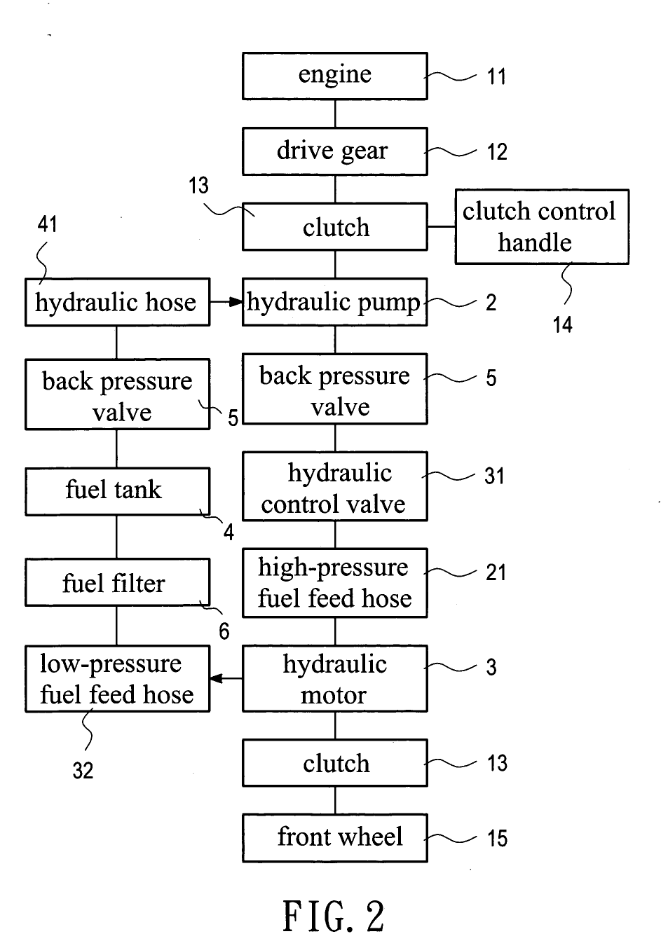

Referring now to FIGS. 1, 2, 3, and 3A, a 2WD motorcycle of belly roll type according to this invention mainly comprises:

a motorcycle 1 on which a clutch control handle 14 is provided to join a drive gear 12 of an engine 11 installed on the motorcycle 1 for control to a clutch 13;

a hydraulic pump 2 on which a high-pressure fuel feed hose 21 is provided to connect with a hydraulic motor 3, a back pressure valve and a directional control valve 22 being provided at a side of the high-pressure fuel feed hose 21 adjacent to the hydraulic pump 2;

a hydraulic motor 3 provided at a side of a front wheel 15 of the motorcycle 1 and connected to a wheel axle of the front wheel 15; a top of the hydraulic motor 3 being provided with a directional control valve 31 and further a fuel outlet of the hydraulic motor being provided with a low-pressure fuel feed hose 31 to connect with a fuel tank 4; a fuel filter being provided at a joint between a low-pressure fuel feed hose 32 and the fuel tank 4;

a fuel tank 4 on which a hydraulic hose 41 is provided to connect with the hydraulic pump 2, a back pressure valve 5 being provided at a side of the hydraulic hose 41 adjacent to the fuel tank 4;

a roller device 7 formed with a block 71 and several rollers 75, a bottom of the block 71 being upward concaved with a container portion 72, a top of the block 71 being provided with several locking portions 73, a side of the block 71 being formed with several piercing holes 74 piercing through two walls of the block 71; central axis at two sides of each roller 75 being protruded with a roller axis 76; each roller 75 being allowed in the container portion 72 of the block 71 and piercing through the piercing holes 74 at two sides of the walls of the block 71 according to the roller axis 76, an exterior of each roller 75 being covered with a layer of colloid; further, the axis 76 of each roller 75 also being possibly formed with pivot hole 77, a pivot 9 being made to pierce through the piercing hole 74 of the block 71 and through the pivot hole 77 of the roller, thereby each roller 75 pivoting on the block 71.

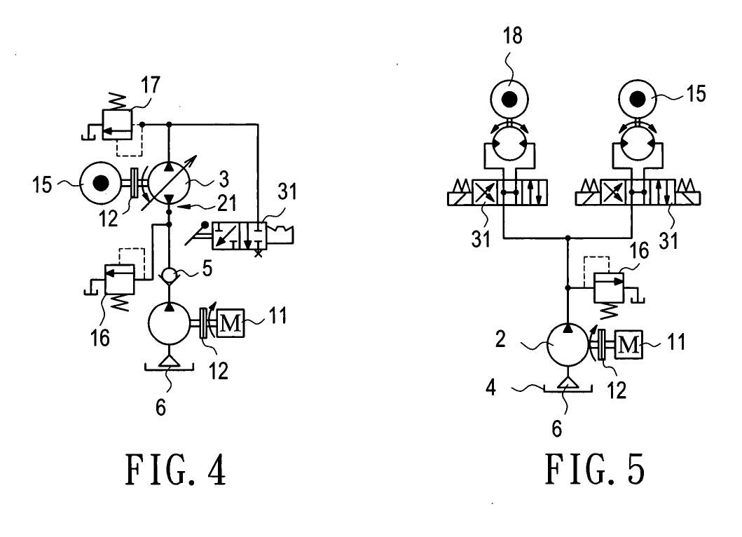

Referring now to FIGS. 1, 2, 4, and 5, the 2WD motorcycle of belly roll type according to this invention keeps a clutch 13 to join a drive gear 12 of an engine 11 of the motorcycle 1 under control using a clutch control handle 14 and drives a hydraulic pump 2 by means of power given by the engine to extract hydraulic fuel from the fuel tank 4 through the hydraulic hose 41 to form hydraulic pressure, and thereby the hydraulic pressure of the hydraulic pump 2 is sent to the hydraulic motor 3 through the high-pressure fuel feed hose 21 and prevents the hydraulic fuel from flowing back to the hydraulic pump 2 by means of the high-pressure fuel feed hose 21, and then the hydraulic motor 3 transforms the hydraulic pressure from the hydraulic pump 2 into a torsion to force the front wheel 15 of the motorcycle 1 to run, while the hydraulic fuel used by the hydraulic motor 3 is delivered to the fuel tank 4 through a low-pressure fuel feed hose 32 and the fuel filter 6 on the low-pressure fuel feed hose 32 is used to filters impurities produced after the hydraulic motor's 3 run; moreover, the back pressure valve 5 is provided on the hydraulic hose 41 connected between the fuel tank 4 and the hydraulic pump 2, thereby preventing a reduced performance of the hydraulic pump 2 due to backflow of the hydraulic fuel, when extracting the hydraulic fuel from the fuel tank 4; furthermore, the hydraulic control valve 31 provided on the hydraulic motor 3 can keep the hydraulic motor 3 to run or stop under control, and next, in order to prevent an excessive pressure occurring, an additional suppression valve (relief valve) 16 and an additional suppression valve 17 may be provided in the hydraulic loop of the 2WD motorcycle of belly roll type according to this invention, and again, the rear wheel 18 of the 2WD motorcycle of belly roll type according to this invention may also be driven by the hydraulic motor 3.

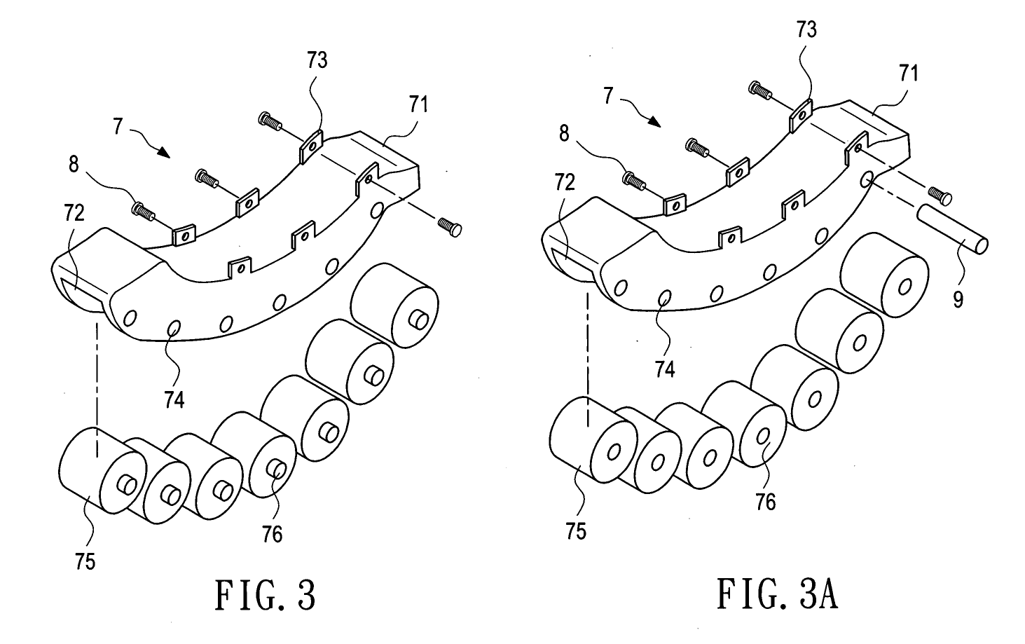

Referring now to FIGS. 1, 3, and 3A, in the 2WD motorcycle of belly roll type according to this invention, the roller device 7 is secured to the belly of motorcycle with screws 8 through the locking portions 73 above the block 71, so when the 2WD motorcycle 1 of belly roll type passes through a higher inclined slope, the roller 75 of the roller device 7 may be used to directly touch a ground surface to roll through an oblique angle formed between the slope and the plane earth for prevention of the belly of motorcycle 1 from being seized due to a distance between the front wheel and the rear wheel.

In comparison with the case cited above as proof and with other conventional skills, the 2WD motorcycle of belly roll type according to this invention further has the following advantages:
1. The hydraulic pump, the hydraulic motor, and the fuel tank are used to form a hydraulic loop, and the hydraulic pressure formed therein is used to force the hydraulic motor to drive the front wheel of motorcycle, thereby providing the power in the front and rear wheels of motorcycle to drive them to roll and then forming a higher horsepower for prevention of motorcycle from being caught in sands due to the wheel's idle running.
2. An additional roller device is installed in the belly of motorcycle, and thereby when the motorcycle passes through a higher inclined slope, the roller of the roller device may be used to directly touch the ground surface to roll through the oblique angle formed between the slope and the plane earth for prevention of the belly of motorcycle from being seized.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A two-wheel drive (2WD) motorcycle of belly roll type mainly comprising a motorcycle as a body, characterized in that a hydraulic pump is provided on the motorcycle, the hydraulic pump is connected to a hydraulic motor provided at a front wheel of the motorcycle through a high-pressure fuel feed hose, and a belly of the motorcycle is provided with a roller device; the hydraulic pump delivers a hydraulic pressure to the hydraulic motor through the high-pressure fuel feed hose, and the hydraulic motor is used to transform the hydraulic pressure into a torsion to force the front wheel of motorcycle to roll.

2. The 2WD motorcycle of belly roll type according to claim 1, wherein the hydraulic pump controls a clutch to connect a drive gear of an engine of the motorcycle through a clutch control handle, and a power given by the engine of motorcycle is used to drive the hydraulic pump to form the hydraulic pressure.

3. The 2WD motorcycle of belly roll type according to claim 1, wherein a back pressure valve is provided at a side of the high-pressure fuel feed hose adjacent to the hydraulic pump.

4. The 2WD motorcycle of belly roll type according to claim 1, wherein a hydraulic control valve is provided on the hydraulic motor.

5. The 2WD motorcycle of belly roll type according to claim 1, wherein the hydraulic pump is provided with an extra hydraulic hose connected to a fuel tank, a back pressure valve is provided at a side of the hydraulic hose adjacent to the fuel tank, the fuel tank is provided with a low-pressure fuel feed hose connected to the hydraulic motor, and a fuel filter is provided on the low-pressure fuel feed hose.

6. The 2WD motorcycle of belly roll type according to claim 1, wherein a rear wheel of the motorcycle may also be connected to a hydraulic motor and the hydraulic pressure formed by the hydraulic pump is used to drive the rear wheel.

7. The 2WD motorcycle of belly roll type according to claim 1, wherein a roller device is formed with a block and several rollers, a bottom of the block is upward concaved with a container portion, a top of the block is provided with several locking portions, a side of the block is formed with several piercing holes piercing through two walls of the block, central axis at two sides of each roller is protruded with a roller axis, each roller is allowed in the container portion of the block and pierces through the piercing holes at two sides of the walls of the block according to the roller axis, and an exterior of each roller is covered with a layer of colloid.

8. The 2WD motorcycle of belly roll type according to claim 7, wherein the axis of each roller may also be formed with a pivot hole, a pivot is made to pierce through the piercing hole of the block and through the pivot hole of the roller, and thereby each roller pivots on the block.
